(19) United States
(12) Patent Application Publication
(10) Pub. No.: US 2026/0163011 A1
(43) Pub. Date: Jun. 11, 2026

(54) ANODE-FREE BATTERIES WITH IMPROVED CYCLING EFFICIENCIES AND METHODS OF MAKING THE SAME

(71) Applicant: BOARD OF TRUSTEES OF THE UNIVERSITY OF ARKANSAS, Little Rock, AR (US)

(72) Inventors: Xiangbo Meng, Fayetteville, AR (US); Darlington Ehijie Imhanzuaria, Fayetteville, AR (US)

(73) Assignee: BOARD OF TRUSTEES OF THE UNIVERSITY OF ARKANSAS, Little Rock, AR (US)

(21) Appl. No.: 19/411,602

(22) Filed: Dec. 8, 2025

Related U.S. Application Data
(60) Provisional application No. 63/729,176, filed on Dec. 6, 2024.

(51) Int. Cl. H01M 4/66; H01M 4/04

(52) U.S. Cl. CPC H01M 4/662; H01M 4/0404; H01M 4/0428; H01M 4/667

(57) ABSTRACT

The invention relates to an anode current collector that includes one or more metal-based layers positioned on a surface of the anode current collector, where the metal-based layer includes a metal and a metal oxide. The invention also relates to energy storage devices that include such anode current collectors. Additionally, the invention relates to methods of forming a coated anode current collector by depositing one or more metal-based layers onto a surface of the anode current collector.

### CROSS-REFERENCE TO RELATED APPLICATIONS

This patent application claims priority from, and incorporates by reference the entire disclosure of, U.S. Provisional Patent Application No. 63/729,176, filed on Dec. 6, 2024

### BACKGROUND

A need exists for the development of anode-free batteries with improved properties. Numerous embodiments of the present disclosure aim to address the aforementioned need.

### SUMMARY OF THE INVENTION

In some embodiments, the present disclosure pertains to an anode current collector that includes one or more metal-based layers positioned on a surface of the anode current collector. In some embodiments, the metal-based layer includes a metal and a metal oxide. Additional embodiments of the present disclosure pertain to energy storage devices that include the anode current collectors of the present disclosure. In some embodiments, the energy storage device is an anode-free battery that includes: a cathode current collector; a cathode; an electrolyte; and an anode current collector that includes one or more metal-based layers positioned on a surface.

Further embodiments of the present disclosure pertain to methods of forming a coated anode current collector. In some embodiments, such methods include depositing one or more metal-based layers onto a surface of the anode current collector. In some embodiments, the depositing includes depositing one or more pre-formed metal-based layers onto the surface of the anode current collector. In some embodiments, the depositing includes forming one or more metal-based layers on the surface of the anode current collector. In some embodiments, the methods of the present disclosure include depositing a metal precursor and an oxide precursor onto the surface of the anode current collector to form one or more metal-based layers on the anode current collector surface. In some embodiments, the method may be repeated multiple times to form multiple metal-based layers on the anode current collector surface. In some embodiments, the methods of the present disclosure also include a step of incorporating the anode current collector as a component of an energy storage device.

### BRIEF DESCRIPTION OF THE DRAWINGS

FIG. 1A provides an illustration of an anode current collector in accordance with various embodiments of the present disclosure.

FIG. 1B provides an illustration of an energy storage device in accordance with various embodiments of the present disclosure.

FIG. 1C illustrates a method of forming an anode current collector in accordance with various embodiments of the present disclosure.

FIG. 2 provides a schematic illustration of an anode-free lithium metal battery (AF-LMB) in accordance with various embodiments of the present disclosure.

FIGS. 3A-3B provide schematic illustrations of AF-LMBs during charge (FIG. 3A) and discharge processes (FIG. 3B).

FIGS. 4A-4B provide schematic illustrations of two atomic layer deposition (ALD) strategies for growing AgₓAl_{y}O compounds, in which Ag exists in its metal state while Al is in its oxide state, i.e., Al₂O₃. FIG. 4A provides an illustration of Strategy I: An ABC ALD strategy for growing AgₓAl_{y}O compounds, using three precursors, Ag(fod)(PEt3) indicated by A, trimethylaluminum (TMA) indicated by B, and water (H₂O) indicated by C. FIG. 4B provides an illustration of strategy II: An ABC+n(AC) ALD strategy for growing AgₓAl_{y}O compounds, where n is an integer (≥1). Strategy II can be used to increase the Ag metal contents.

FIG. 5 provides in-situ quartz crystal microbalance (QCM) measurements of the AgₓAl_{y}O growth via the ABC ALD strategy at 130° C., showing a linear growth of AgₓAl_{y}O. During the measurements, Ag(fod)(PEt3) was heated to 95° C. while both TMA and water were maintained at room temperature. This ALD process was performed cyclically by dosing Ag(fod)(PEt3) for 0.7 s, purging for 15 s, dosing TMA for 0.3 s, purging for 15 s, dosing water for 0.2 s, and purging for 15 s.

FIG. 6 provides in-situ QCM measurements of the AgₓAl_{y}O growth via the ABC ALD strategy at 200 and 250° C., showing a linear growth of AgₓAl_{y}O. During the measurements, Ag(fod)(PEt3) was heated to 95° C. while both TMA and water remained at room temperature. This ALD process was performed cyclically by dosing Ag(fod)(PEt3) for 0.7 s, purging for 10 s, dosing TMA for 0.3 s, purging for 10 s, dosing water for 0.2 s, and purging for 10 s.

FIGS. 7A-7B provide scanning electron microscopy (SEM) images of the AgₓAl_{y}O deposition over nitrogen-doped graphene nanosheets (N-GNS) (FIG. 7A) and Si at 200° C. (FIG. 7B) after 200 ALD cycles. This ALD process was performed cyclically for 200 times by dosing Ag(fod)(PEt3) for 0.7 s, purging for 10 s, dosing TMA for 0.3 s, purging for 10 s, dosing water for 0.2 s, and purging for 10 s.

FIGS. 8A-8B provide in-situ QCM measurements of the AgₓAl_{y}O growth via the ABC+3(AC) ALD strategy at 200° C., showing a linear growth of AgₓAl_{y}O. During the measurements, Ag(fod)(PEt3) was heated to 95° C. while both TMA and water remained at room temperature. This ALD process was performed cyclically by dosing Ag(fod)(PEt3) for 0.7 s, purging for 10 s, dosing TMA for 0.3 s, purging for 10 s, dosing water for 0.2 s, and purging for 10 s.

FIG. 9 provides SEM images of N-GNS (Ag-0) and AgₓAl_{y}O deposited on N-GNS for 100 (Ag-100), 200 (Ag-200), 300 (Ag-300), and 400 (Ag-400) ALD cycles of ABC+3(AC) via Strategy II, deposited at 200° C. The AgₓAl_{y}O layer becomes thicker with increased ALD cycles.

FIG. 10 provides SEM images of bare copper foil (Bare-Cu) and copper foil coated by 150 ALD cycles of ABC+3(AC) AgxAlyO (Cu @ Ag 150) via Strategy II, deposited at 200° C. The AgₓAl_{y}O-coated Cu becomes smoother.

FIG. 11 shows energy dispersive x-ray (EDX) mapping on the area cycled by the green square, showing conformal coating of Ag, Al, and O elements. This confirms that the conformal coating of 150 ALD cycles of ABC+3(AC) AgₓAl_{y}O via Strategy II, deposited at 200° C.

FIGS. 12A-12B show the analysis of X-ray photoelectron spectroscopy (XPS) on the AgₓAl_{y}O film deposited at 200° C. via Strategy II. FIG. 12A is a XPS survey while FIG. 12B shows high-resolution XPS spectra of Ag 3d, Al 2p, and O 1s.

FIGS. 13A-13D show the Coulombic efficiency of Li∥Cu cells adopting bare and AgₓAl_{y}O-coated Cu foils, tested at 2 mA cm⁻² and 1 mAh cm⁻² (FIG. 13A), 5 mA cm⁻² and 1 mAh cm⁻² (FIG. 13B), 2 mA cm⁻² and 2 mAh cm⁻² (FIG. 13C) and 5 mA cm⁻² and 2 mAh cm⁻² (FIG. 13D). AgₓAl_{y}O was deposited by adopting the super ALD process of ABC+3(AC) at 200° C. for different cycles (50, 100, 150, 200, 250, and 300). The resultant AgₓAl_{y}O-coated Cu foils were named as Cu@AgₓAl_{y}O-50, Cu@AgₓAl_{y}O-100, Cu@AgₓAl_{y}O-150, Cu@AgₓAl_{y}O-200, Cu@AgₓAl_{y}O-250, and Cu@AgₓAl_{y}O-300, respectively. The electrolyte was 1 M LiTFSI in 1:1 DOL:DME (v/v).

FIGS. 14A-14B show the effect of Cu@AgₓAl_{y}O-150 on the Cu∥NMC811 AF-LMB. FIG. 14A exhibits that Cu@AgₓAl_{y}O-150, compared to bare Cu, dramatically improved the resultant Cu@AgₓAl_{y}O-150∥NMC811 cell's cyclability and Coulombic efficiency. FIG. 14B exhibits that the charge/discharge profiles of bare Cu∥NMC811 and Cu@AgₓAl_{y}O-150∥NMC811 cells, exhibiting improved performance due to the adoption of Cu@AgₓAl_{y}O-150. These cells were tested at 0.1 C in the voltage range of 2.5-4.4 V at room temperature.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Since the commercialization of lithium-ion batteries (LIBs) in 1991, LIBs have dominated consumer portable electronics and recently have penetrated the market of electric vehicles. Typically, state-of-the-art LIBs adopt a lithiated metal oxide as the cathode and a graphite anode soaked in a liquid organic electrolyte. Many lithiated metal oxides have been investigated and commercialized in LIBs, such as LiCoO₂ (LCO), LiNiₓMn_{y}CozO₂ (x+y+z=1, NMCs), LiNiₓCo_{y}Al_{z}O₂ (x+y+z=1, NCAs) and LiMn₂O₄ (LMO), and LiFePO₄ (LFP).

While LIBs are approaching their energy limits (less than 250 Wh/kg in the cylindrical cells and less than 300 Wh/kg in the pouch cells), new battery systems enabling higher energy density are urgently needed to support such continuous development. In this context, replacing the graphite anode of LIBs with lithium (Li) metal to couple with existing LIB cathodes is currently a promising technical strategy. The resultant lithium metal batteries (LMBs) promise a much higher energy density, up to 2 times higher than that of LIBs using the graphite anode, for Li metal enables an extremely high capacity of 3860 mAh/g, over ten times higher than that of the graphite anode (372 mAh/g).

In addition, Li metal has the lowest redox potential (−3.04 V) when compared with standard hydrogen electrodes (SHE). In LMBs, Li is extracted from the cathode side and then deposited on the anode side during the charging process while extracted from the anode side and then deposited on the cathode side during the discharging process. With the adoption of lithiated cathodes (e.g., LCO, NMCs, NCAs, LMO, LFP, and Li₂S), it is theoretically feasible for LMBs to fully utilize the total amount of Li stored in the cathodes without an addition of Li metal anodes but just leave the bare anode current collector (typically copper foils) on the anodic side. Such cell build-ups are so called anode-free LMBs (AF-LMBs), in which the amount of Li+ ions all originate from the lithiated cathodes.

Thus, AF-LMBs are initially in a fully discharged state and have no excess Li metal on the anodic side. Once they are charged, they will gain their Li metal anodes.

AF-LMBs can exploit the full potential of the lithium-containing cathode systems. Compared to traditional LMBs with a pre-deposited Li anode, AF-LMBs eliminate the excessive use of Li and save anode volume and weight, resulting in the highest volumetric and gravimetric energy density. On the other hand, removing the pre-deposited Li anode also reduces the cost of battery production and maintenance, enabling the lowest cost. Furthermore, AF-LMBs also improve battery safety with no excessive Li and reduced electrolytes.

Thus, AF-LMBs have great potentials as a next-generation battery technology over LIBs. They can boost energy density, save costs, and improve battery safety to the maximum level. Although AF-LMBs are very promising, they face two main hurdles that hinder them from commercialization.

A first issue with AF-LMBs is the continuous formation of solid electrolyte interphase (SEI) during Li plating. The SEI layer is the layer between Li metal and the liquid electrolyte. The SEI layer is the product due to the reaction of the Li metal with the liquid electrolyte. A stable SEI is critical to protect the liquid electrolyte and Li metal from consumption. Otherwise, the continuous formation of SEI will deplete Li metal and the electrolyte, leading to cell failure.

Additionally, Li deposition on the copper is uneven and leads to the dendritic growth. The Li dendrites are formed with a layer of SEI once they contact the liquid electrolyte. Lithium dendrites also pose safety issues, for they may grow into the cathode side and thereby short the cell with fire or explosion.

In particular, SEI formation and Li dendritic growth are interconnected and self-accelerated. Following a Li plating process, a Li stripping process produces lots of dead Li dispersed in the liquid electrolyte and an SEI layer on the Cu foil. In return, they are prone to aggravate SEI formation and Li dendritic growth in the following plating process. As a consequence, the initial Li storage in the cathode is liable to deplete quickly in limited Li-plating-stripping cycles and the plating-stripping cycles exhibit a decreased Coulombic efficiency (CE). The Coulombic efficiency is the ration between the stripping capacity and the plating capacity (0≤CE≤1).

To tackle these issues, many different strategies have been investigated to design new electrolytes and current collectors for improved electrochemical performance of AF-LMBs, in terms of Coulombic efficiency of cells and capacity retention and sustainable capacity of cathodes. However, the research on AF-LMBs is still in its infant stage and more studies are needed for fundamental understandings and technology commercialization.

In sum, anode-free batteries, including AF-LMBs, show promise in achieving optimal energy density, low costs, and improved safety. However, anode-free batteries, including AF-LMBs, are hindered from commercialization due to the low Coulombic efficiencies. Numerous embodiments of the present disclosure aim to address the aforementioned limitations.

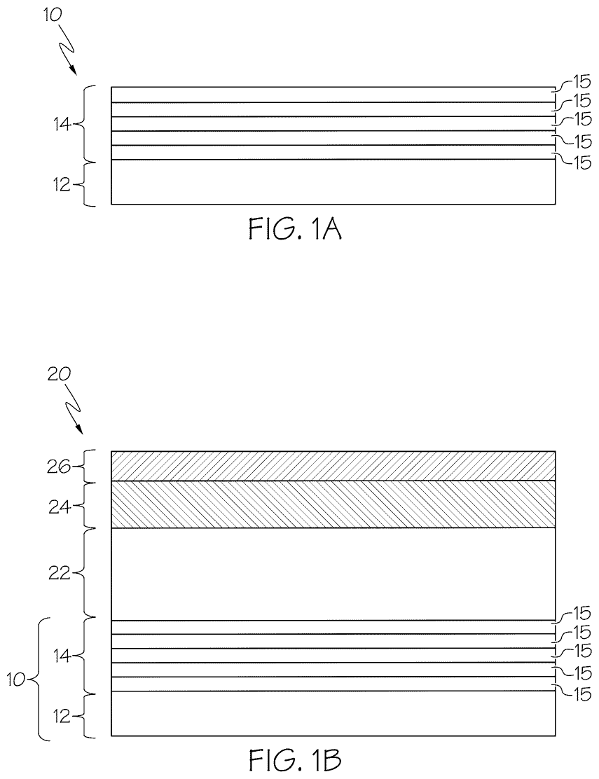

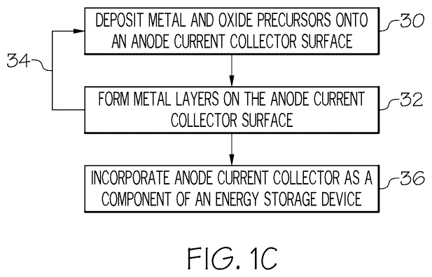

In some embodiments, the present disclosure pertains to an anode current collector. With reference to anode current collector 10 in FIG. 1A for illustrative purposes, anode current collector 10 may include a metal-based layer 14 positioned on surface 12 of the anode current collector. In some embodiments, the metal-based layer 14 includes a plurality of layers 15. In some embodiments, the metal-based layers include a metal and a metal oxide.

Additional embodiments of the present disclosure pertain to energy storage devices that include the anode current collectors of the present disclosure. In some embodiments, the energy storage device is an anode-free battery. With reference to anode-free battery 20 in FIG. 1B for illustrative purposes, anode-free battery 20 may include: a cathode current collector 26; a cathode 24; an electrolyte 22; and anode current collector 10, which includes one or more metal-based layers 14 positioned on surface 12. In some embodiments, the metal-based layer 14 includes a plurality of layers 15.

Further embodiments of the present disclosure pertain to methods of forming a coated anode current collector. In some embodiments, such methods include depositing one or more metal-based layers onto a surface of the anode current collector. In some embodiments, the depositing includes depositing one or more pre-formed metal-based layers onto the surface of the anode current collector. In some embodiments, the depositing includes forming one or more metal-based layers on the surface of the anode current collector. In some embodiments illustrated in FIG. 1C, the methods of the present disclosure include depositing a metal precursor and an oxide precursor onto the surface of the anode current collector (step 30) to form one or more metal-based layers on the anode current collector surface (step 32). In some embodiments, the method may be repeated multiple times to form multiple metal-based layers on the anode current collector surface (step 34). In some embodiments, the methods of the present disclosure also include a step of incorporating the anode current collector as a component of an energy storage device (step 36).

As set forth in more detail herein, the anode current collectors, energy storage devices, and methods of the present disclosure can have numerous embodiments.

### Anode Current Collectors

The anode current collectors of the present disclosure can be in various forms. For instance, in some embodiments, the anode current collector is in the form of a copper foil, an aluminum foil, a nickel foil, or combinations thereof. In some embodiments, the anode current collector is in the form of a copper foil. In some embodiments, the anode current collector is in the form of a graphene sheet. In some embodiments, the graphene sheet includes a nitrogen-doped graphene nanosheet (N-GNS).

### Metal-Based Layers

The anode current collectors of the present disclosure can include various metal-based layers on their surfaces. Additionally, the methods of the present disclosure may form various metal-based layers on anode current collector surfaces. For instance, in some embodiments, the metal-based layers include a metal and a metal oxide. In some embodiments, the metal in the metal-based layer includes a silver or an alloy thereof. In some embodiments, the metal oxide in the metal-based layer includes an aluminum oxide or an alloy thereof. In some embodiments, the metal-based layers include a silver metal layer.

In some embodiments, the metal-based layers include an aluminum oxide layer. In some embodiments, the aluminum oxide layer includes, without limitation, Al₂O₃, alumina trihydrate, or combinations thereof.

In some embodiments, the metal-based layers include a silver-aluminum oxide layer. In some embodiments, the silver-aluminum oxide layer includes the following formula: AgₓAl_{y}O. In some embodiments, Ag is in its metal state while Al is in its oxide state. In some embodiments, each of x and y is a number of more than 0.

The metal-based layers of the present disclosure may be in various forms. For instance, in some embodiments, the metal-based layers are in the form of a film, nanoparticles, or combinations thereof.

The metal-based layers of the present disclosure may include various layers. For instance, in some embodiments, the metal-based layers include at least 50 stacked layers. In some embodiments, the metal-based layers include at least 100 stacked layers. In some embodiments, the metal-based layers include at least 150 stacked layers.

The metal-based layers of the present disclosure may be deposited onto anode current collector surfaces in various manners. For instance, in some embodiments, the metal-based layers are deposited through atomic layer deposition (ALD).

### Energy Storage Devices

The anode current collectors of the present disclosure may be components of various energy storage devices. Additionally, the methods of the present disclosure may incorporate anode current collectors as components of various energy storage devices.

For instance, in some embodiments, the energy storage devices of the present disclosure include a battery. In some embodiments, the battery includes, without limitation, solid-state batteries, lithium-ion batteries, lithium-metal batteries, anode-free batteries, anode-free lithium metal batteries, battery cells, or combinations thereof.

In some embodiments, the energy storage devices of the present disclosure include battery cells. In some embodiments, the battery cells include, without limitation, Li∥Cu cells, Cu∥NMC811 cells, Cu∥LFP cells, Cu∥Li₂S cells, or combinations thereof.

In some embodiments, the energy storage devices of the present disclosure include an anode-free battery. In some embodiments, the anode-free battery is an anode-free lithium metal battery. In some embodiments, the anode-free battery includes: a cathode current collector, a cathode, an electrolyte, and an anode current collector of the present disclosure.

The energy storage devices of the present disclosure can include various cathode current collectors. For instance, in some embodiments, the cathode current collectors include, without limitation, aluminum, nickel, copper, stainless steel, titanium, carbon-based materials, conductive polymers, or combinations thereof.

The energy storage devices of the present disclosure can include various cathodes. For instance, in some embodiments, the cathode includes, without limitation, a lithiated cathode, lithium cobalt oxide (LCO), nickel manganese cobalt (NMCs), nickel cobalt aluminum (NCAs), lithium ion manganese oxide (LMO), lithium iron phosphate (LFP), lithium sulfide (Li₂S), or combinations thereof.

The energy storage devices of the present disclosure can include various electrolytes. For instance, in some embodiments, the electrolytes include, without limitation, solid-state electrolytes (e.g., ceramic and/or polymer electrolytes, ionic liquid electrolytes, gel polymer electrolytes, dual-salt liquid electrolytes, fluorinated electrolytes, or combinations thereof.

### Methods of Forming Coated Anode Current Collectors

Additional embodiments of the present disclosure pertain to methods of forming coated anode current collectors. Such methods generally include depositing one or more metal-based layers onto a surface of the anode current collector. In some embodiments, the depositing includes depositing one or more pre-formed metal-based layers onto the surface of the anode current collector.

In some embodiments, the depositing includes forming one or more metal-based layers on the surface of the anode current collector. In some embodiments, such metal-based layer formation steps include depositing a metal precursor and an oxide precursor onto a surface of the anode current collector. In some embodiments, the metal precursor and the oxide precursor are deposited through atomic layer deposition (ALD). In some embodiments, the ALD is repeated multiple times to form at least 50 stacked layers of the metal oxide layer. In some embodiments, the ALD is repeated multiple times to form at least 100 stacked layers of the metal oxide layer. In some embodiments, the ALD is repeated multiple times to form at least 150 stacked layers of the metal oxide layer.

The methods of the present disclosure may deposit various metal precursors onto an anode current collector surface. For instance, in some embodiments, the metal precursor includes, without limitation, a silver precursor, an aluminum precursor, or combinations thereof.

In some embodiments, the metal precursor includes an aluminum precursor. In some embodiments, the aluminum precursor is trimethylaluminum (TMA, Al(CH₃)₃).

In some embodiments, the metal precursor includes a silver precursor. In some embodiments, the silver precursor is triethylphosphine(6,6,7,7,8,8,8-heptafluoro-2,2-dimethyl-3,5-octanedionato) silver(I) (i.e., (Ag(fod)(PEt₃) or Ag(C₃F₇COCHCOC₄H₉)P(CH₂CH₃)₃).

The methods of the present disclosure may also deposit various metal precursors onto an anode current collector surface. For instance, in some embodiments, the oxide precursor includes water (H₂O).

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Improving Lithium Cycling Efficiency of Anode-Free Lithium Metal Batteries

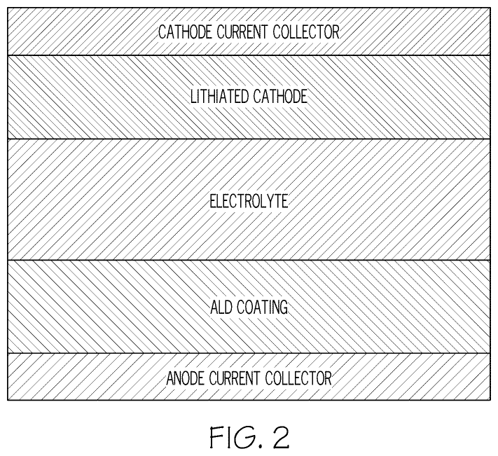

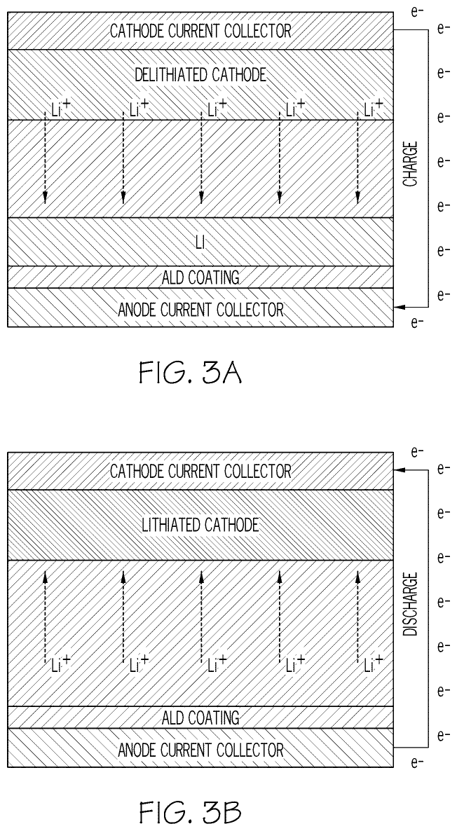

In this Example, Applicant has developed anode-free lithium metal batteries (AF-LMBs) through applying a new surface coating of silver aluminum oxide (AgₓAl_{y}O) compounds over anode current collectors (ACC, e.g., copper foils) via atomic layer deposition (FIG. 2). The atomic layer deposition (ALD)-deposited layer could be a layer of AgₓAl_{y}O nanoparticles or a layer of a dense AgₓAl_{y}O film, depending on ALD parameters (e.g., ALD substrate, ALD temperature, and/or ALD cycles). The AgₓAl_{y}O-coated ACC is used to couple with a lithiated cathode on a cathode current collector (CCC) to form an AF-LMB cell. An electrolyte is filled in the space between the ACC and the cathode to facilitate the transport of Li⁺ ions during charge and discharge processes. The cell is initially in a discharge state and, thus, a charge process is needed to functionalize it. During a charge process (FIG. 3A), Li⁺ ions are transferred from the lithiated cathode the ALD-coated ACC via the electrolyte while electrons move in the same direction by taking an external circuit. The Li⁺ ions and electrons meet on the ACC surface to form a Li metal layer and grow thicker with the continuous deposition.

The ALD coating ensures that the Li plating (deposition) is proceeded in a two-dimensional mode with no dendritic growth and little SEI formation through modifying the ACC surface. The ALD coating changes the ACC from a lithiophobic nature to a lithiophilic surface property. This change ensures the Li plating to proceed in a two-dimensional mode. In a following discharge process (FIG. 3B), Li⁺ ions are transferred back to the cathodic side while electrons move back in the same direction by taking the external circuit. They meet at the cathodic side and recover the delithiated cathode into its lithiation state.

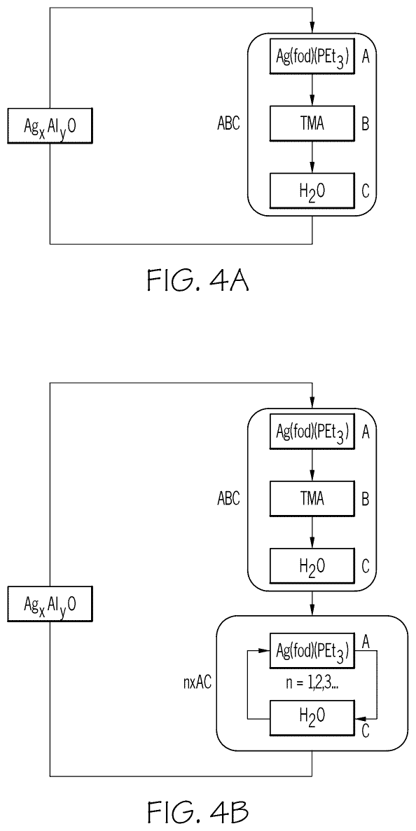

In this Example, the ALD AgₓAl_{y}O coating is a novel inorganic composite, a mixture of Ag metal and Al₂O₃, and can be tuned in composition by adopting different ALD processes (FIGS. 4A-4B). There are two ALD strategies developed in this Example. First, Applicant developed an ABC ALD strategy (Strategy I) (FIG. 4A), in which triethylphosphine(6,6,7,7,8,8,8-heptafluoro-2,2-dimethyl-3,5-octanedionato)silver(I) (i.e., Ag(fod)(PEt3), Ag(C₃F₇COCHCOC₄H₉)P(CH₂CH₃)₃, indicated by A), trimethylaluminum (i.e., TMA, Al(CH₃)₃, indicated by B), and water (i.e., H₂O, indicated by C) were used as precursors. Second, Applicant developed an ABC+n(AC) ALD strategy (Strategy II) (FIG. 4B), in which n is an number (≥1). Compared to the first ALD strategy, the second strategy could enable AgₓAl_{y}O compounds with higher Ag contents.

### Example 1.1. Strategy I for Growing AgₓAl_{y}O Via ALD

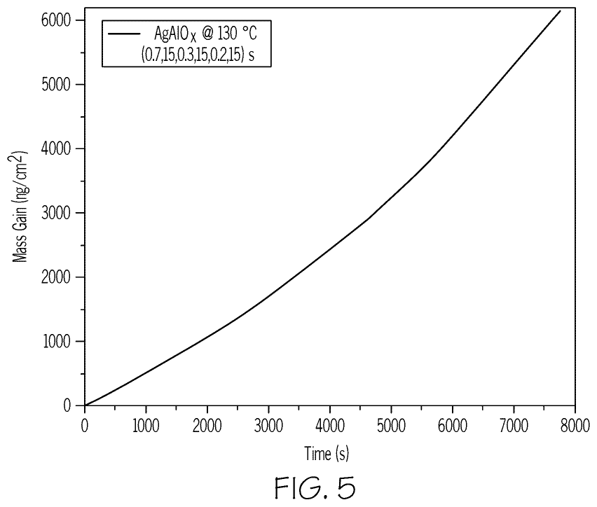

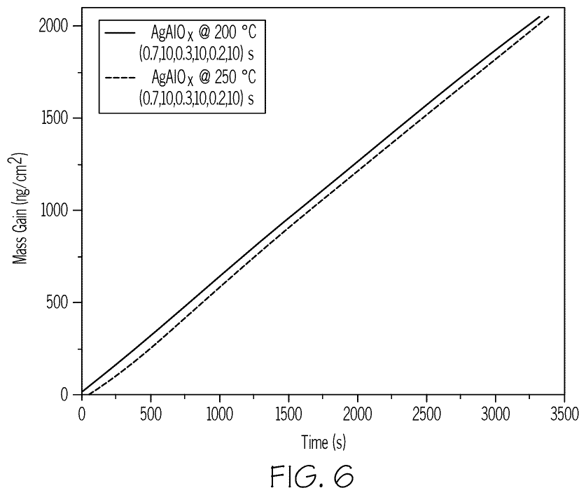

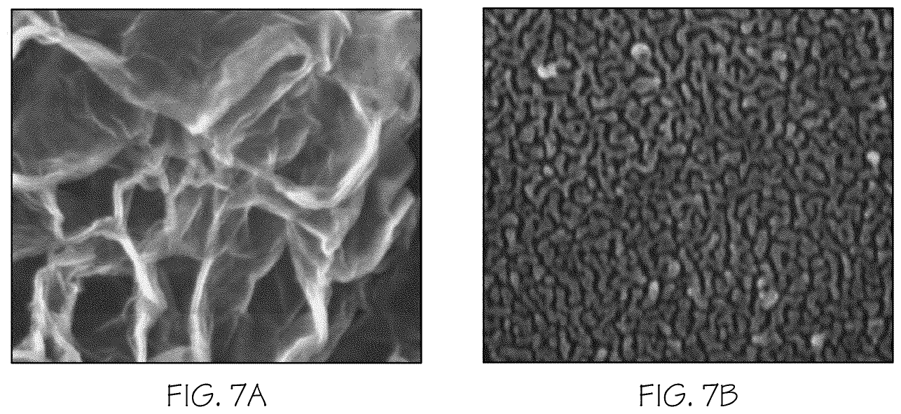

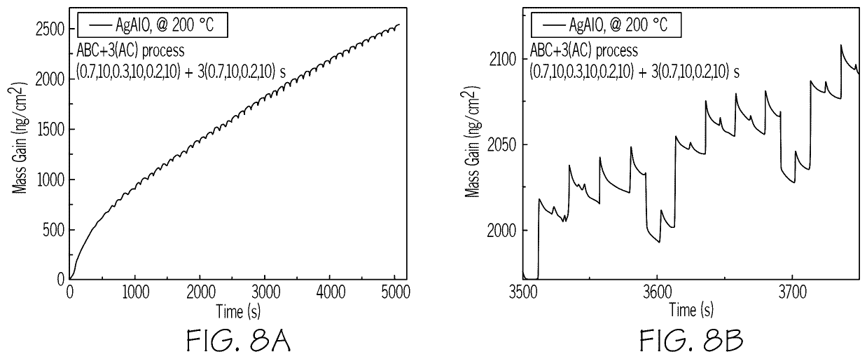

Strategy I for growing AgₓAl_{y}O via ALD is illustrated in FIG. 4A. Strategy I proceeds an ABC ALD process. The feasibility of this ABC ALD process has been verified by Applicant's in-situ quartz crystal microbalance (QCM) measurements. As shown in FIG. 5, QCM measurements showed a linear growth of AgₓAl_{y}O at 130° C.. Such an ALD process could also be deposited at a lower or higher temperature. For example, such an ALD process was verified at 200 and 250° C. using in-situ QCM measurements, showing a linear growth of AgₓAl_{y}O (FIG. 6).

Applicant also observed the deposition of AgₓAl_{y}O on silicon (Si) and nitrogen-doped graphene nanosheets (N-GNS). Applicant revealed that a conformal coating was formed on N-GNS (FIG. 7A) while an island structure was formed on Si (FIG. 7B) deposited at 200° C. after 200 ALD cycles.

### Example 1.2. Strategy II for Growing AgₓAl_{y}O Via ALD

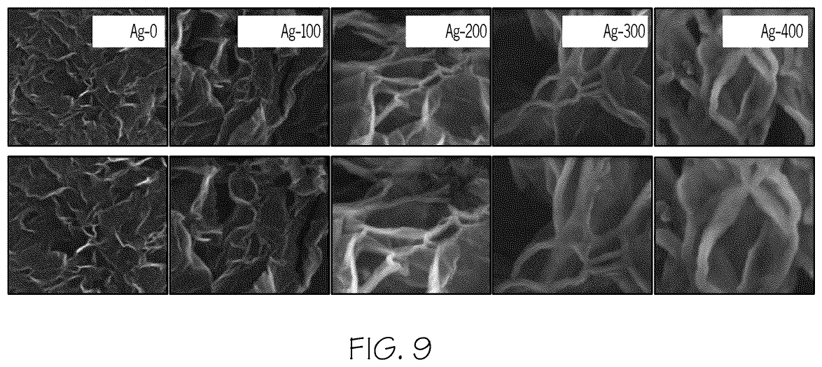

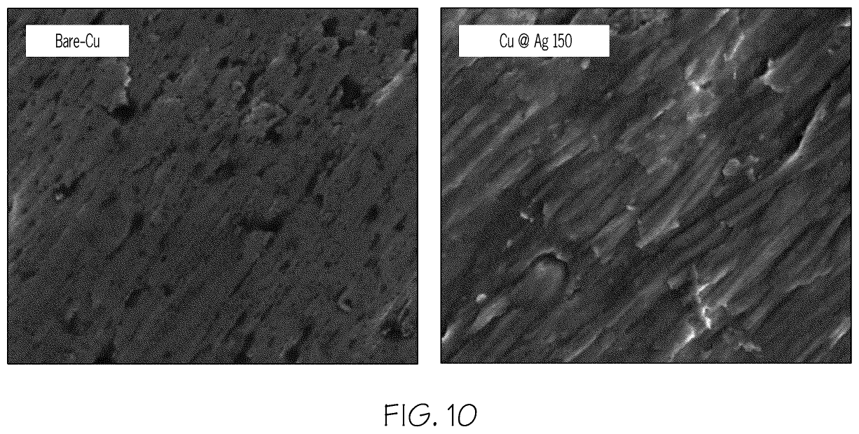

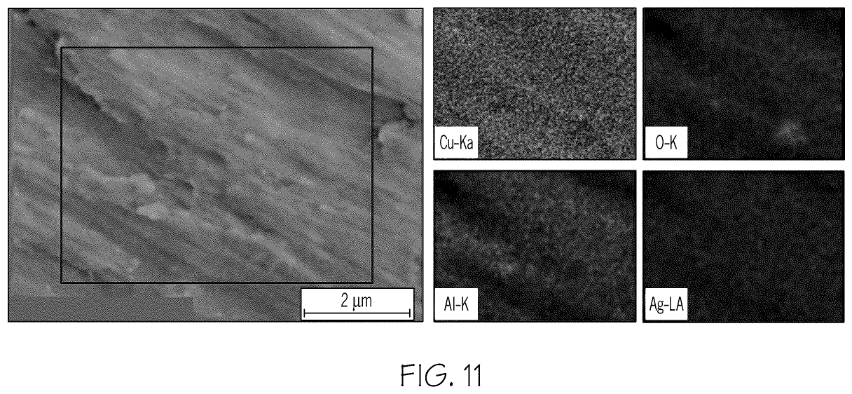

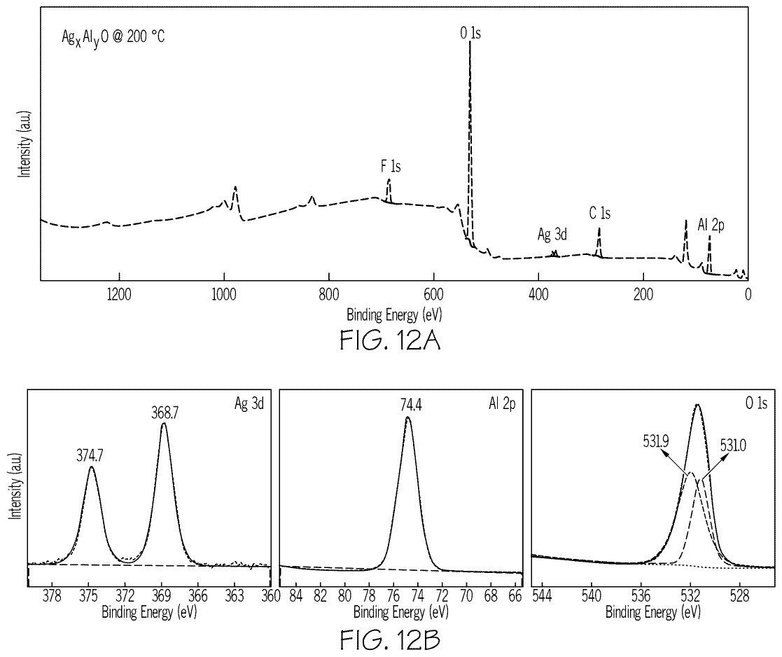

As illustrated in FIG. 4B, Strategy II for growing AgₓAl_{y}O combines an ABC ALD process with an AC ALD process. In order to increase the Ag content, one ABC ALD cycle is preferred to combine with multiple AC ALD cycles. As illustrated in FIGS. 8A-8B, a super-ALD cycle of AgₓAl_{y}O consists of one cycle of ABC sub-ALD process and three cycles of AC sub-ALD process (i.e., ABC+3(AC)), which is verified by in-situ QCM measurements. Such a super-ALD process of ABC+3(AC) was deposited on N-GNS (FIG. 9) and copper foils (FIGS. 10-11). The resultant deposition was uniform and conformal. The resultant films were controllable in thickness. The resultant AgₓAl_{y}O film is analyzed by X-ray photoelectronic spectroscopy (XPS) (FIG. 12). FIG. 12A shows that XPS detected Ag, Al, O, C, and F. The C and F are due to the incomplete reaction of the Ag precursor. FIG. 12B shows that Ag is in its metal state while Al is in its oxide state, Al₂O₃ or Al(OH)₃.

### Example 1.3 Electrochemical Tests to Demonstrate the Effects of the ALD-Deposited AgₓAlyₒ Coatings on AF-LMBs

Applicant first investigated the Coulombic efficiency of asymmetric Li∥Cu cells. AgₓAl_{y}O were deposited on Cu foils with different super-ALD cycles of ABC+3(AC) at 200° C. The resultant Cu foils were named as Cu@AgₓAl_{y}O-XXX, where XXX is the super-ALD cycles, such as 50, 100, 150, 200, 250, and 300.

Two liquid organic electrolytes were used: (1) one carbonate electrolyte: 1.2 M LiPF₆ in ethylene carbonate (EC)/ethylmethyl carbonate (EMC) (3:7 by weight) and (2) one ether electrolyte: 1 M bis(trifluoromethane)sulfonamide lithium salt (LiTFSI) in 1,3-dioxolane (DOL) and 1,2-dimethoxyethane (DME) (1:1, v/v). To test Li∥Cu cells, Li will be first deposited on Cu with a constant current density (e.g., 2 or 5 mA cm⁻²) under a fixed areal capacity (e.g., 1 mAh cm⁻²). Then, the deposited Li on the Cu side will be stripped and deposited back to the Li side. The stripping process is controlled and terminated by achieving a cell voltage of 1 V.

Besides Li∥Cu cells, Applicant also investigate the effects of the ALD-deposited AgₓAl_{y}O coatings in AF-LMB cells. One type of AF-LMB cells is Cu∥NMC811, in which Cu is either bare or coated by the ALD-deposited AgₓAl_{y}O. All Cu∥NMC811 cells is tested in the voltage window of 2.5-4.4 V at 0.1 C (1 C=200 mA/g).

### Example 1.4. Proof of Concept

Applicant used AgₓAl_{y}O-coated Cu foils to couple with Li foils and investigated the resultant Li∥Cu asymmetric cells' Coulombic efficiency. It is expected that, compared to bare Cu foils, the AgₓAl_{y}O-coated Cu foils will help improve the cells' Coulombic efficiency, due to their lithiophilic property.

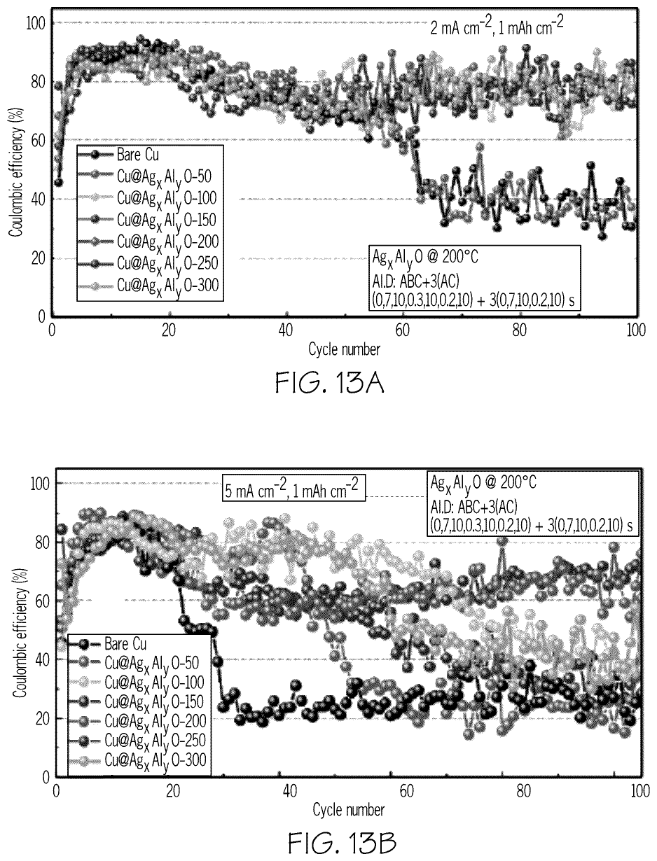

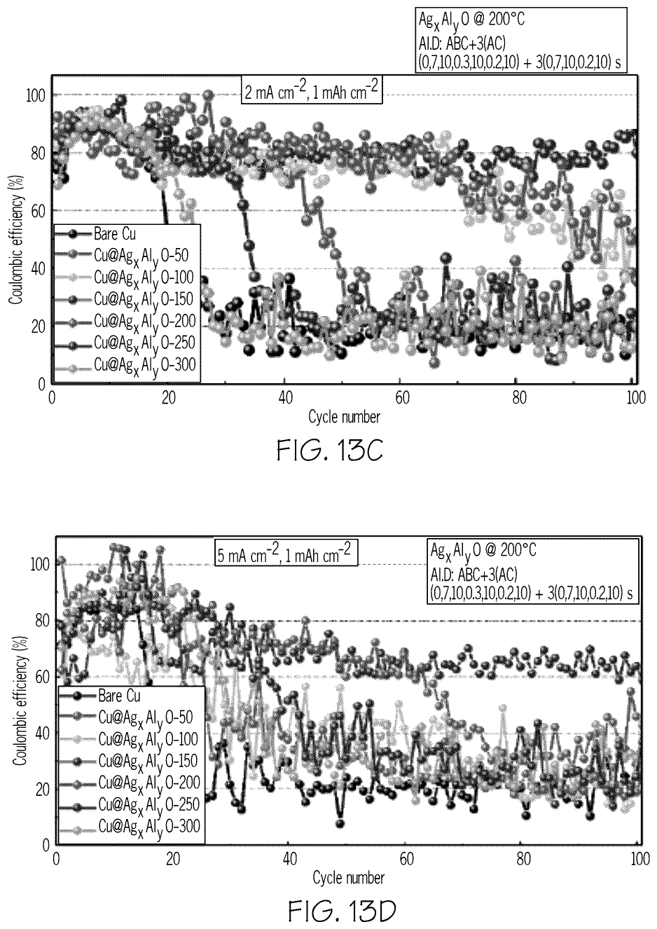

In this respect, Applicant tested Li∥Cu cells by adopting bare and AgₓAl_{y}O-coated Cu foils. AgₓAl_{y}O was deposited by adopting the super-ALD process of ABC+3(AC) with different super-ALD cycles (50, 100, 150, 200, 250, and 300). As shown in FIGS. 13A-13D, AgₓAl_{y}O-coated Cu foils improved the Coulombic efficiency of Li∥Cu cells and extended the cells' cyclability. In addition, it was observed that there exists an optimal coating thickness (i.e., an optimal super-ALD cycle number) to achieve the highest Coulombic efficiency. Based on the data of FIGS. 13A-13D, it is concluded that AgₓAl_{y}O-150 is the best coating thickness. These results revealed that the ALD-deposited AgₓAl_{y}O coating is very promising to coat anode current collectors for developing AF-LMBs. The ALD AgₓAl_{y}O coating could change the Cu foils from a lithiophobic nature to a lithiophilic property. This change made lithium plating much easier and mitigated SEI and lithium dendrites from formation.

Applicant used AgₓAl_{y}O-coated Cu foils to couple with NMC811 and investigated the resultant Cu∥NMC811 AF-LMB cells' cyclability and Coulombic efficiency. It is expected that, compared to bare Cu foils, the AgₓAl_{y}O-coated Cu foils will help improve the cells' cyclability and Coulombic efficiency, due to their lithiophilic property.

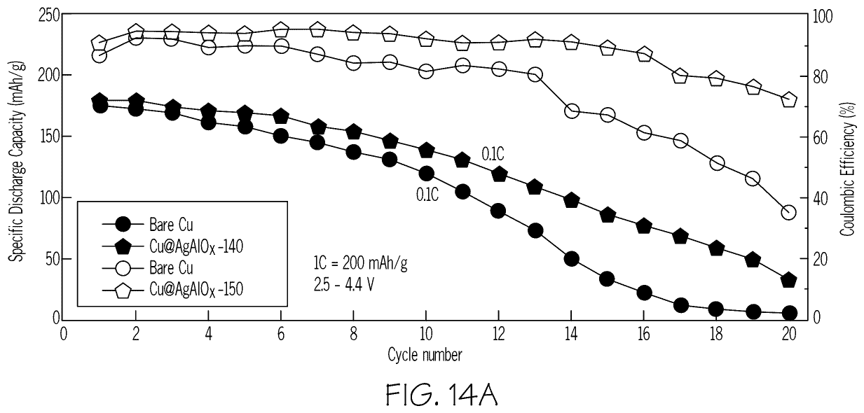

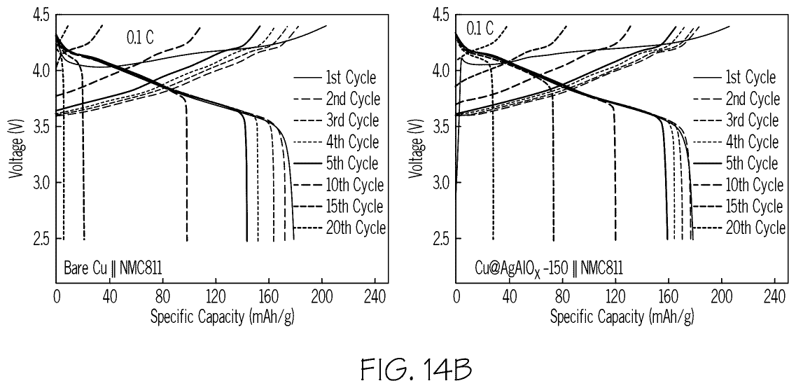

In this respect, Applicant tested Cu∥NMC811 cells by adopting bare and AgₓAl_{y}O-coated Cu foils. AgₓAl_{y}O was deposited by adopting the super-ALD process of ABC+3(AC) with 150 super-ALD cycles. As shown in FIGS. 14A-14B, AgₓAl_{y}O-coated Cu foils improved the cyclability and Coulombic efficiency of Cu∥NMC811 cells. These results revealed that the ALD-deposited AgₓAl_{y}O coating is very promising to coat anode current collectors for developing AF-LMBs. The ALD AgₓAl_{y}O coating could change the Cu foils from a lithiophobic nature to a lithiophilic property. This change made lithium plating much easier and mitigated SEI and lithium dendrites from formation.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. An anode current collector comprising one or more metal-based layers positioned on a surface of the anode current collector, wherein the metal-based layer comprises a metal and a metal oxide.

2. The anode current collector of claim 1, wherein the metal in the metal-based layer comprises a silver or an alloy thereof, and wherein the metal oxide in the metal-based layer comprises an aluminum oxide or an alloy thereof.

3. The anode current collector of claim 1, wherein the metal-based layer comprises a silver-aluminum oxide layer comprising the following formula: AgₓAl_{y}O, wherein each of x and y is a number of more than 0.

4. The anode current collector of claim 1, wherein the metal-based layer comprises at least 50 stacked layers.

5. The anode current collector of claim 1, wherein the metal-based layer is deposited through atomic layer deposition (ALD).

6. An energy storage device comprising an anode current collector, wherein the anode current collector comprises one or more metal-based layers positioned on a surface of the anode current collector, wherein the metal-based layer comprises a metal and a metal oxide.

7. The energy storage device of claim 6, wherein the energy storage device is a battery.

8. The energy storage device of claim 7, wherein the battery is selected from the group consisting of solid-state batteries, lithium-ion batteries, lithium-metal batteries, anode-free batteries, anode-free lithium metal batteries, battery cells, or combinations thereof.

9. The energy storage device of claim 7, wherein the battery is an anode-free battery comprising:
a cathode current collector,
a cathode,
an electrolyte,
and the anode current collector.

10. The energy storage device of claim 6, wherein the metal in the metal-based layer comprises a silver or an alloy thereof, and wherein the metal oxide in the metal-based layer comprises an aluminum oxide or an alloy thereof.

11. The energy storage device of claim 6, wherein the metal-based layer comprises a silver-aluminum oxide layer comprising the following formula: AgₓAl_{y}O, wherein each of x and y is an number of more than 0.

12. The energy storage device of claim 6, wherein the metal-based layer comprises at least 50 stacked layers.

13. A method of forming a coated anode current collector, said method comprising:
depositing one or more metal-based layers onto a surface of the anode current collector, wherein the metal-based layer comprises a metal and a metal oxide.

14. The method of claim 13, wherein the depositing comprises depositing one or more pre-formed metal-based layers onto the surface of the anode current collector.

15. The method of claim 13, wherein the depositing comprises forming one or more metal-based layers on the surface of the anode current collector.

16. The method of claim 15, wherein the forming comprises depositing a metal precursor and an oxide precursor onto the surface of the anode current collector.

17. The method of claim 16, wherein the metal precursor and the oxide precursor are deposited through atomic layer deposition (ALD).

18. The method of claim 16, wherein the metal precursor is selected from the group consisting of a silver precursor, an aluminum precursor, or combinations thereof.

19. The method of claim 16, wherein the oxide precursor comprises water (H₂O).

20. The method of claim 13, wherein the metal-based layer comprises a silver-aluminum oxide layer comprising the following formula: AgₓAl_{y}O, wherein each of x and y is a number of more than 0.
